(19) United States
(12) Patent Application Publication
(10) Pub. No.: US 2004/0238067 A1
(43) Pub. Date: Dec. 2, 2004

(54) Polycrystalline diamond tips on sawheads for application in the timber industry

(76) Inventor: Scott A. Ries, Grove City, OH (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/852,534

(22) Filed: May 24, 2004

Related U.S. Application Data
(60) Provisional application No. 60/473,511, filed on May 27, 2003.

(51) Int. Cl. A01G 23/08; B27M 3/00; A01G 23/06

(52) U.S. Cl. 144/4.1; 144/34.1; 144/24.12

(57) ABSTRACT

Methods for the harvesting of timber using a cutting sawhead having cutting elements of polycrystalline diamond (PCD) are provided. A sawhead having cutting elements of PCD extends the useful life of the blades, increases productivity and decreases downtown in timber harvesting methods. A method for harvesting timber in rocky and sandy soils using a sawhead with PCD tipped cutters is described. A cutting sawhead having cutting elements of PCD provide increased useful life compared to conventional steel and tungsten carbide cutting elements.

### CROSS-REFERENCE TO RELATED APPLICATIONS

The present invention claims priority to U.S. Provisional Application Ser. No. 60/473,511, entitled, “Polycrystalline Diamond Tips on Cutters for High-Speed Disc Sawheads for Application in the Timber Industry,” filed on May 27, 2003, herein incorporated by reference in its entirety.

### BACKGROUND

The present invention generally relates to timber harvesting and more particularly to equipping high-speed sawheads with polycrystalline diamond (PCD) cutters.

Steel and tungsten carbide cutters have been employed on timber harvesting equipment that is equipped with high-speed disc sawheads. Since the highest quality wood is located in the base of a tree, timber harvesters often cut trees as low to the ground as possible. This introduces rock, sand and other abrasive materials into the cutting zone and severely limits the working life of the carbide cutters.

A variety of timber harvesting equipment has been proposed in the prior art. U.S. Pat. No. 4,467,849 herein incorporated by reference, describes a felling head for use in harvesting trees. The felling head carries a pair of circular saws and means for positioning and gripping a tree to be felled. The saws are rotated and moved relative to the positioning and gripping means to, between them, cut through a positioned and gripped tree. These saws typically are fitted with tungsten carbide cutting tools. These cutters are quickly dulled and/or chipped by contact with rocks, sand and other aggregates near the base of the tree.

U.S. Pat. No. 3,797,540 herein incorporated by reference describes a machine for converting standing trees into logs of predetermined length comprising a tree severing and processing assembly mounted on the front end of a vehicle. The assembly includes a tree severing unit located close to the ground, an upright mast, tree gripping and feeding assemblies rotatably mounted on the mast, tree delimbers on the mast corresponding to the gripping and feeding assemblies, a tree cutoff unit, and a log storage rack arranged so that the assembly has a tree severing station and a tree processing station. At the tree severing station, the tree is severed from the ground, and lifted while being maintained in a vertical position.

Timber cutters contact rocks, sand and other aggregates near the base of the tree in timber harvesting methods leading to increased wear on the cutters. Other problems encountered in the timber industry include down time to remove such aggregates or replace traditional sawheads worn by or damaged by the aggregates. There is a need to increase productivity of tree harvesting equipment by increasing the useful life of such equipment, especially, in rock and other debris laden soil. It has been found that providing a high speed disc sawhead comprising polycrystalline diamond tips increases productivity, increases useful life and decreases downtime in timber harvesting methods.

### SUMMARY

Embodiments of the present invention include methods for the harvesting of growing timber using a cutting sawhead having one or more cutting elements of polycrystalline diamond (PCD) to cut one or more trees. One embodiment of the present invention is a method for harvesting timber in rocky and sandy soils using a sawhead with PCD tipped cutters. Another embodiment of the present invention is a method of increasing useful life of a timber harvesting saw using PCD tipped cutters in a harvesting sawhead. Another embodiment of the present invention is a method of increasing productivity of a timber harvesting saw using PCD tipped cutters in a harvesting sawhead. Another embodiment of the present invention is a method of decreasing downtime in timber harvesting by providing a timber harvesting saw with PCD tipped cutters. One embodiment of the present invention provides cutting elements with increased useful life compared to conventional steel and tungsten carbide cutting elements.

Another embodiment of the present invention is a timber harvester cutting sawhead including one or more circular saw blades having one or more PCD cutting elements about its periphery. Another embodiment of the present invention is a PCD cutting element for use in a timber cutting sawhead that includes one or more teeth affixed to a carrier, wherein the teeth include particles of PCD. In several embodiments of the invention a PCD cutting element may be used in known sawhead configurations such as in as in a high-speed disc sawhead.

### BRIEF DESCRIPTION OF THE DRAWINGS

For a fuller understanding of the nature and advantages of the present invention, reference should be had to the following detailed description taken in connection with the accompanying drawings, in which:

FIG. 1 illustrates a timber harvesting blade having a plurality of PCD cutting elements distributed about its periphery according to one embodiment of the present invention.

FIG. 2 is a perspective view of a PCD cutting element with four PCD cutting teeth according to one embodiment of the present invention.

The drawings will be described in further detail below.

### DETAILED DESCRIPTION

For simplicity and illustrative purposes, the principles of the invention are described by referring mainly to an embodiment thereof. In the following description, numerous specific details are set forth in order to provide a thorough understanding of the invention. It will be apparent, however, to one of ordinary skill in the art, that the invention may be practiced without limitation to these specific details as the invention is to be limited only by the claims appended hereto. In other instances, well known methods and structures have not been described in detail so as not to unnecessarily obscure the invention.

It must also be noted that as used herein and in the appended claims, the singular forms “a”, “an”, and “the” include plural reference unless the context clearly dictates otherwise. Unless defined otherwise, all technical and scientific terms used herein have the same meanings as commonly understood by one of ordinary skill in the art. Although any methods similar or equivalent to those described herein can be used in the practice or testing of embodiments of the present invention, the preferred methods are now described. All publications mentioned herein are incorporated by reference. Nothing herein is to be construed as an admission that the invention is not entitled to antedate such disclosure by virtue of prior invention.

In the following description, various embodiments of a method of harvesting timber using polycrystalline diamond (PCD) tips in a saw or blade are provided. The examples refer to a method of harvesting timber, namely a method of harvesting timber wherein PCD tips are incorporated into traditional timber harvesting high-speed sawheads. For example, PCD cutting elements may be incorporated into a felling head device used in harvesting tress described in U.S. Pat. No. 4,467,849, herein incorporated by reference. As another example, PCD cutting elements may be incorporated into a machine for converting standing trees into logs comprising a tree severing and processing assembly mounted on the front of a vehicle described in U.S. Pat. No. 3,797,540, herein incorporated by reference. It is to be understood that the invention is not limited to these particular cutting devices and methods, but that PCD cutting elements may be incorporated into any device that may cut timber including blades, saws, and cutters.

Timber cutting blades are typically relatively large, for example about 50-60 inches in diameter. The blades create a width of cut of about 2 inches at cutting speeds of up to about 1500 rpm. Typical blade speeds of around 1150 rpm may slow to around 500 rpm when cutting, depending upon the size of the tree. For example, a 20-inch diameter tree may be cut in about 1-1.5 seconds. The timber cutting machines may move over relatively rough terrain near the base of a tree. The cutting blade may encounter rock, sand, nails, stones, wire, and other objects that are quite detrimental to conventional steel and even carbide tipped saw blades. The timber cutting machines move at a speed of around 5 mph over very rough and rugged terrain, including gravel, soil, rock, and sand, in all seasons. Saw blades may operate during conditions of high and low temperatures, varying from about 0° F. to about 90° F., and during periods of low/high humidity and rain. These parameters may be difficult to control in harvesting methods. Thus, a cutting blade that is able to operate in such an environment over all ranges of parameters is preferred in timber harvesting.

In one embodiment of the present invention, saw blades containing PCD cutting elements will decrease downtime, increase productivity, and increase useful life compared to conventional steel and tungsten carbide cutting elements. PCD tips can be manufactured for attachment to traditional timber harvesting carbide cutters for use in high-speed disk sawheads and felling attachments.

We have found that using PCD cutting elements provides unexpected success in timber harvesting applications. Using PCD cutting tips in place of carbide cutting tips for timber harvesting/felling equipment has not been previously suggested because PCD has a lower bending strength and lower failure load than does carbide. The ability to withstand loads and display bending strength has been thought by the art to be important in selecting timber harvesting cutting tip materials.

However, Applicants have found that PCD tipped sawheads, despite the fact that PCD has a lower bending strength and failure load than carbide materials, may withstand the bending and loading requirements of felling and harvesting methods while providing a longer useful life than the carbide sawheads.

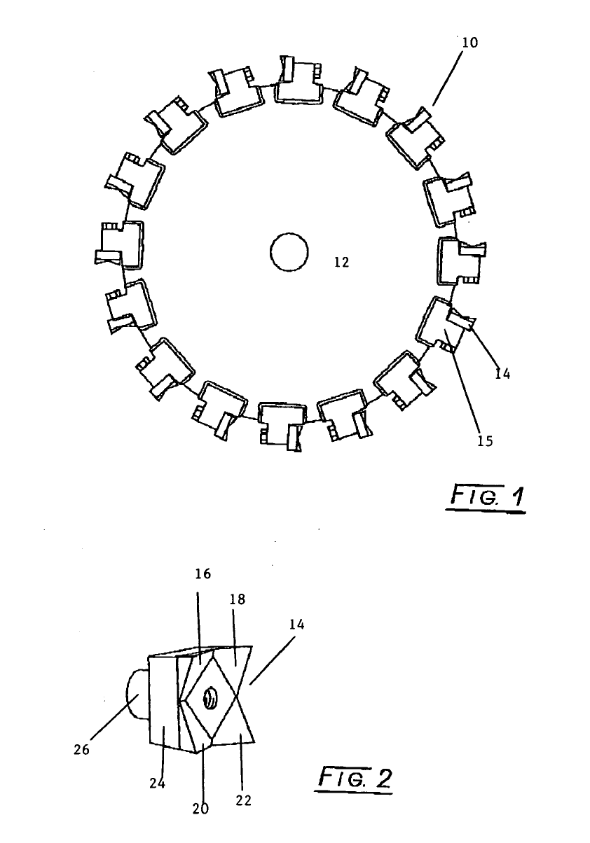

In one embodiment of the present invention, PCD tips are mounted on a circular blade that is utilized on a sawhead. For example, a timber harvesting blade, 10, is illustrated in FIG. 1 having a central aperture, 12, for mounting to the timber harvester, and a plurality of PCD cutting elements distributed about its periphery. For convenience, one of these PCD cutting elements, 14, will be used to illustrate the invention. The remaining PCD cutting elements retained by blade 10 may be of the same design as element 14, or they may vary in design. That is, each PCD cutting element distributed about blade 14 may vary in size, in number of individual PCD cutters or teeth, in particle size, in particle concentration, in particle toughness, and may contain mixtures of PCD particles with other superabrasive particles, such as polycrystalline cubic boron nitride. Typically, PCD particle size is about 4 to about 30 μm. Moreover, the number of individual elements 14 may be more or less than that shown in FIG. 1. The distribution of the cutting elements also can be regular or irregular, though preferably in a predetermined pattern. Blade 10 most often will be a steel blade, such as is commonly used today in timber harvesting. PCD cutting element 14 is installed in a holder, 15, which is attached to the blade 10.

An exemplary individual PCD cutting element 14 is illustrated in FIG. 2. In this embodiment, the cutting element 14 has four PCD cutting teeth, 16, 18, 20, and 22. Referring to FIG. 1, sixteen to twenty of these individual cutting elements may be located about the periphery of blade 10, although the actual number may vary. The number of teeth per cutting element 14 may also vary, for example from about 3 to about 5 or greater. The shape of the teeth may vary, and are preferably triangular with a slope as illustrated in FIG. 2. The teeth may be attached by brazing, sintering or any known method to a carrier, 24. The carrier 24 contacts a shank, 26, on the side opposite the cutting teeth. The shank 26 fits into holder 15 disposed about the periphery of blade 10. The shank 26 may be press fitted into a peripheral aperture in blade 10, although brazing, welding, or other such technique typically is used for attachment of cutting element 14 to blade 10. Alternatively, the carrier 24 and the shank 26 may be hollow for receiving a threaded bolt for attaching PCD cutting element 14 into a mating interiorly threaded aperture located in holder 15. Thus, it will be seen that a wide variety of techniques may be employed for attaching element 14 to blade 10.

The carrier 24 may be formed from a cemented carbide, such as tungsten carbide. The carrier 24 may be an existing carbide tooth used today by a timber harvesting machine. By using an existing carbide tooth to support the PCD elements, expenses in commercially implementing the present invention will be minimized.

One embodiment of the present invention is a method for harvesting timber in rocky and sandy soils using a sawhead with PCD tipped cutters. A blade as described in FIGS. 1 and 2 may be used in areas where silica sand and other fine aggregate are present in the soil. Another embodiment of the present invention is a method of increasing useful life of timber harvesting blades. Tooth life is estimated in hours of use with an average for conventional carbide teeth lasting about 300-500 hours in abrasive (rocky) cutting conditions and approximately 1000 hours in non-abrasive applications (lack of rocky soil).

In one embodiment of the present invention, PCD tipped cutters, having a grain size of about 25 μm were tested in abrasive cutting conditions. These cutters were operated for about 500 hours and have not exhausted their useful life. Thus, replacing the tungsten carbide with PCD tipped cutters will decrease downtime and increase productivity of timber harvesting machines.

A PCD tipped cutter of one embodiment of the present invention is a PCD abrasive particle compact. A PCD abrasive particle compact is a polycrystalline mass of diamond abrasive particles bonded together to form an integral, tough, high-strength mass. Such components may be bonded together in a particle-to-particle self-bonded relationship, by means of a bonding medium disposed between the particles, or by combinations thereof. The abrasive particle content of the abrasive compact is high and there is an extensive amount of direct particle-to-particle bonding. Abrasive compacts may be made under elevated or high pressure and temperature (HP/HT) conditions at which the diamond particles are crystallographically stable. For example, several processes may be employed to make PCD including those methods described in U.S. Pat. Nos. 3,136,615, 3,141,746, and 3,233,988, each herein incorporated by reference.

A supported abrasive particle compact, herein termed a composite compact, is a PCD abrasive particle compact, which is bonded to a substrate material, such as cemented tungsten carbide. Compacts of this type are described, for example, in U.S. Pat. Nos. 3,743,489, 3,745,623, and 3,767,371, each herein incorporated by reference. The bond may be formed either during or subsequent to the formation of the abrasive particle compact. Composite abrasive compacts may be used as such in the working surface of an abrasive tool.

Fabrication of the composite compact may be achieved by placing a cemented carbide substrate into the container of a press. A mixture of diamond grains or diamond grains and catalyst binder is placed atop the substrate and compressed under HP/HT conditions. The metal binder migrates from the substrate and “seeps” through the diamond grains to promote a sintering of the diamond grains. The diamond grains contact each other to form a diamond layer, which concomitantly is bonded to the substrate along a conventionally planar interface. Metal binder can remain disposed in the diamond layer within pores defined between the diamond grains.

### EXAMPLE 1

Carbide and PCD samples, with carbide as the substrate, were tested to measure four-point bending strength data in consonance with specifications laid out in ASTM-C1161, entitled “Standard Test Method For Flexural Strength of Advanced Ceramics at Ambient Temperature”. The carbide sample was RTW Grade 394 tungsten carbide (Rogers Tool Works, Rogers, Ariz.). There were three PCD samples tested: (1) PCD compact with average grain size of about 5 μm; (2) PCD compact with average grain size of about 25 μm, and (3) PCD compact with average grain size of about 4 μm.

The samples were cut with a wire-EDM to a nominal cross-sectional area of 4 mm×2.8 mm (w×h) and a total length of 50 mm. The loading span is 20 mm and the support span is 40 mm length. The PCD segments were tested such that the PCD layer was in tension (the bottom part of the test specimen). The data showed the carbide sample exhibited the highest bending strength and highest failure load.

Failure load for the carbide sample was about 1300-1850 N. Bending strength of the carbide sample was about 1300-1800 MPa. The failure loads and bending strength for the PCD samples were about 800-1250 N and about 800-1200 MPa, respectively. PCD materials across all particle sizes tested supplied adequate failure loads and bending strength in timber sawheads.

### EXAMPLE 2

PCD tipped cutters as described in FIG. 2, having a grain size of about 25 μm, were placed into a timber sawhead as described in FIG. 1 and tested in abrasive (rocky) cutting conditions. These cutters were operated for about 500 hours and did not exhaust their useful life. The cutters also were able to perform the cutting over the 500 hours, supplying adequate bending strength and load bearing in traditional felling and harvesting applications. Thus, replacing the tungsten carbide with PCD tipped cutters will decrease downtime and increase productivity of timber harvesting machines.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all amounts and percentages are by weight, unless otherwise expressly indicated.

What is claimed is:

1. A timber harvester cutting sawhead comprising one or more circular saw blades having one or more PCD cutting elements about its periphery.

2. The timber harvester cutting sawhead of claim 1, wherein the sawhead is a high-speed disc sawhead.

3. The timber harvester cutting sawhead of claim 1, wherein the sawhead comprises a pair of circular saws.

4. The timber harvester cutting sawhead of claim 1, wherein the cutting sawhead comprises up to about 20 PCD cutting elements.

5. The timber harvester cutting sawhead of claim 1, wherein the one or more PCD cutting elements comprise one or more teeth affixed to a carrier, wherein the teeth comprise particles of PCD.

6. The timber harvester cutting sawhead of claim 5, wherein:
the carrier is located on the side of the cutting element opposite the teeth;
the carrier contacts a shank; and
the shank is adapted to connect the cutting element to a cutting sawhead.

7. The timber harvester cutting sawhead of claim 5, wherein the carrier comprises a cemented carbide.

8. The timber harvester cutting sawhead of claim 5, wherein the carrier comprises a tungsten carbide.

9. The timber harvester cutting sawhead of claim 1, wherein the one or more PCD cutting elements comprise PCD particles having a particle size between about 4 μm and about 30 μm.

10. A PCD cutting element for use in a timber cutting sawhead comprising one or more teeth affixed to a carrier, wherein the teeth comprise particles of PCD.

11. The cutting element of claim 10, wherein the teeth have a triangular shape.

12. The cutting element of claim 10, wherein:
the carrier is located on the side of the cutting element opposite the teeth;
the carrier contacts a shank; and
the shank is adapted to connect the cutting element to a cutting sawhead.

13. The cutting element of claim 10, wherein the particles are between about 4 μm and about 30 μm.

14. The cutting element of claim 10, wherein the carrier comprises cemented carbide.

15. The cutting element of claim 10, wherein the carrier comprises tungsten carbide.

16. A method for harvesting timber comprising using a cutting sawhead having one or more polycrystalline diamond (PCD) cutting elements to cut one or more trees.

17. The method of claim 16, wherein the sawhead comprises at least one circular saw blade.

18. The method of claim 16, wherein the one or more PCD cutting elements are installed about the periphery of the cutting sawhead.

19. The method of claim 16, wherein the cutting sawhead comprises up to about 20 PCD cutting elements.

20. The method of claim 16, wherein the one or more PCD cutting elements comprise one or more teeth affixed to a carrier, wherein the teeth comprise particles of PCD.

21. The method of claim 20, wherein:
the carrier is located on the side of the cutting element opposite the teeth;
the carrier contacts a shank; and
the shank is adapted to connect the cutting element to a cutting sawhead.

22. The method of claim 20, wherein the carrier comprises a cemented carbide.

23. The method of claim 20, wherein the carrier comprises a tungsten carbide.

24. The method of claim 16, wherein the one or more PCD cutting elements comprise PCD particles having a particle size between about 4 μm and about 30 μm.
